(19) United States
(12) Patent Application Publication
(10) Pub. No.: US 2006/0133292 A1
(43) Pub. Date: Jun. 22, 2006

(54) System and method for measuring performance of internet phone protocol

(76) Inventors: Kyou Ho Lee, Daejeon-city (KR); Gil Young Choi, Daejeon-city (KR); Dong Guk Je, Daejeon-city (KR); Jaewoo Park, Daejeon-city (KR); Young Sun Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/114,337

(22) Filed: Apr. 26, 2005

(30) Foreign Application Priority Data
Dec. 17, 2004 (KR) 10-2004-0108157

(51) Int. Cl. G01R 31/08; H04L 12/66

(52) U.S. Cl. 370/252; 370/352

(57) ABSTRACT

Provided are a system and a method for measuring the performance of an Internet phone protocol, which are easy to be realized and are highly efficient in terms of managing system resources because they measure the performance of an Internet phone protocol projected by removing unnecessary, complex paths and the respective processing routines while taking into consideration main functions of the Internet phone protocol separately from exceptional functions of the Internet phone protocol. The system includes: a user environment processing unit, which receives a protocol to be tested and removable paths of the protocol to be tested and provides information on performance indexes; a projection processing unit, which projects the protocol to be tested by removing unnecessary paths related to exceptional operations of the protocol to be tested in consideration of the removable paths of the protocol to be tested; and a projected protocol processing unit, which applies the projected protocol to a caller and a callee to make the projected protocol ready to be tested.

### BACKGROUND OF THE INVENTION

This application claims the benefit of Korean Patent Application No. 10-2004-0108157, filed on Dec. 17, 2004, in the Korean Intellectual Property Office, the disclosure of which is incorporated herein in its entirety by reference.

1. Field of the Invention

The present invention relates to a system and a method for measuring the performance of an Internet phone protocol, and more particularly, to a system and a method for measuring the performance of an Internet phone protocol, which are easy to be realized and are highly efficient in terms of managing system resources because they measure the performance of an Internet phone protocol projected by removing unnecessary, complex paths and the respective processing routines while taking into consideration main functions of the Internet phone protocol separately from exceptional functions of the Internet phone protocol.

2. Description of the Related Art

The Internet has been designed to transmit data providing best effort services. In other words, the Internet does not discriminate packet transmission functions according to the types of services but makes the same best effort to process each of a plurality of packets regardless of priorities among the packets. Accordingly, an urgent task, such as transmitting real-time multimedia data that needs to be immediately transmitted over the Internet may be laid aside because of a less urgent task, such as downloading files. Thus, in case of network traffic, audio packets may be severely damaged or delayed in the process of being transmitted over the Internet, thus deteriorating the quality of audio data contained in the audio packets. Due to these characteristics of the Internet, and particularly, real-time and other characteristics of Internet phone services, it is necessary to measure the performance of Internet phone protocols.

Conventionally, the performance of an Internet phone protocol is measured taking into consideration all paths of the Internet phone protocol including those which do not affect the performance of the Internet phone protocol. This type of measurement technique is difficult to be realized and is inefficient in terms of exploiting system resources.

### SUMMARY OF THE INVENTION

The present invention provides a system for measuring the performance of an Internet phone protocol, which is easy to be realized and is highly efficient in terms of managing system resources because it measures the performance of an Internet phone protocol projected by removing unnecessary, complex paths and the respective processing routines while taking into consideration main functions of the Internet phone protocol separately from exceptional functions of the Internet phone protocol.

The present invention also provides a method of measuring the performance of an Internet phone protocol, which is easy to be realized and is highly efficient in terms of managing system resources because it measures the performance of an Internet phone protocol projected by removing unnecessary complex paths and the respective processing routines while taking into consideration main functions of the Internet phone protocol separately from exceptional functions of the Internet phone protocol.

According to an aspect of the present invention, there is provided a system for measuring the performance of an Internet phone protocol. The system includes: a user environment processing unit, which receives a protocol to be tested and removable paths of the protocol to be tested and provides information on performance indexes; a projection processing unit, which projects the protocol to be tested by removing unnecessary paths related to exceptional operations of the protocol to be tested in consideration of the removable paths of the protocol to be tested; and a projected protocol processing unit, which applies the projected protocol to a caller and a callee to make the projected protocol ready to be tested.

The system may also include: a signal conversion unit, which converts a logical message generated together with the projected protocol into a physical message that can be interpreted by the device whose protocol needs to be tested and converts a physical message generated by the device whose protocol needs to be tested into a logical message that can be interpreted by the projected protocol processing unit; a call generation unit, which generates a call corresponding to the projected protocol; and a data collection and statistical analysis unit, which collects data generated by the signal conversion unit and the call generation unit and statistically analyzes the collected data. The Internet phone protocol is a session initiation protocol (SIP), and the device whose protocol needs to be tested is an SIP proxy server.

The removable paths may include: a convenience path, which is removable for the convenience of measuring the performance of an Internet phone protocol; a termination path, which is removable on the assumption that only one of the caller or the callee is able to issue a BYE request; a network path, which is generated due to network circumstances; a false information path, which is generated when the caller has false termination information or requirements related to the formation of an SIP message are not met; and an error path, which is generated due to hardware flaws or a user's intent when entities have hardware flaws or a user of a user agent declines to initiate a session.

The projected protocol processing unit may realize a plurality of pairs of callers and callees as multiple threads, which operate in parallel.

The call generation unit may generate a call setting request message at a user's request, the call setting request message may be used for calculating the performance indexes together with data output from the signal conversion unit, and the user environment processing unit can view the performance indexes.

The performance indexes may include throughput and call setting time of the SIP proxy server. The throughput of the SIP proxy server is represented by a maximum number of calls per sec.

According to another aspect of the present invention, there is provided a method of measuring the performance of an Internet phone protocol. The method includes: projecting an Internet phone protocol to be tested by applying removable paths to the Internet phone protocol and then removing unnecessary paths related to exceptional processes; and measuring the performance of the projected Internet phone protocol. The Internet phone protocol is an SIP, and the performance of the projected Internet phone protocol is measured using an SIP proxy server.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a system for measuring the performance of an Internet phone protocol according to an exemplary embodiment of the present invention;

FIG. 2 is a diagram illustrating a table that specifies removable paths of an Internet phone protocol and circumstances under which they can be removed;

FIG. 3 is a projected state transition diagram illustrating a session initiation protocol (SIP) used in a system and a method for measuring the performance of an Internet phone protocol according to an exemplary embodiment of the present invention; and

FIG. 4 is a flowchart illustrating a system and a method for measuring the performance of an Internet phone protocol according to an exemplary embodiment of the present invention.

### DETAILED DESCRIPTION OF THE INVENTION

The present invention will now be described more fully with reference to the accompanying drawings in which exemplary embodiments of the invention are shown.

An Internet phone protocol, such as a session initiation protocol (SIP), serves to transmit multimedia data and establish and control sessions. In addition to such main functions, an Internet phone protocol provides exceptional functions, such as dealing with errors. In the present invention, a system and a method for measuring the performance of an Internet phone protocol, which are easy to be realized and are highly efficient in terms of managing system resources because they measure the performance of an Internet phone protocol projected by removing unnecessary, complex paths and the respective processing routines by taking into consideration main functions of the Internet phone protocol separately from exceptional functions of the Internet phone protocol, are provided.

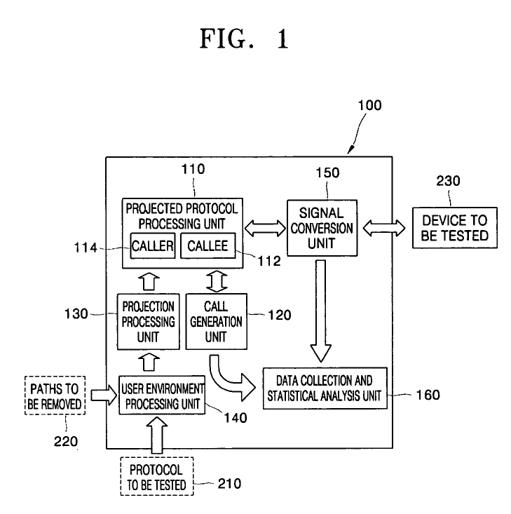

FIG. 1 is a block diagram of a system 100 for measuring the performance of an Internet phone protocol according to an exemplary embodiment of the present invention. Referring to FIG. 1, the system includes a projected protocol processing unit 110, a call generation unit 120, a projection processing unit 130, a user environment processing unit 140, a signal conversion unit 150, and a data collection and statistical analysis unit 160. The system 100 receives a protocol 210 to be tested and paths 220 to be removed via the user environment processing unit 140 and is connected to a device 230 to be tested via the signal conversion unit 150.

The protocol 210 to be tested, which is input to the system 100, is a protocol having all possible paths, including paths established for a normal operating state and paths established for an abnormal, erroneous operating state. The paths 220 to be removed are paths that can be excluded from the measurement of the performance of the protocol 210 to be tested in consideration of performance indexes of the protocol 210 to be tested, such as processing rates. The projection processing unit 130 excludes the paths 220 to be removed from the measurement of the performance of the protocol 210 to be tested.

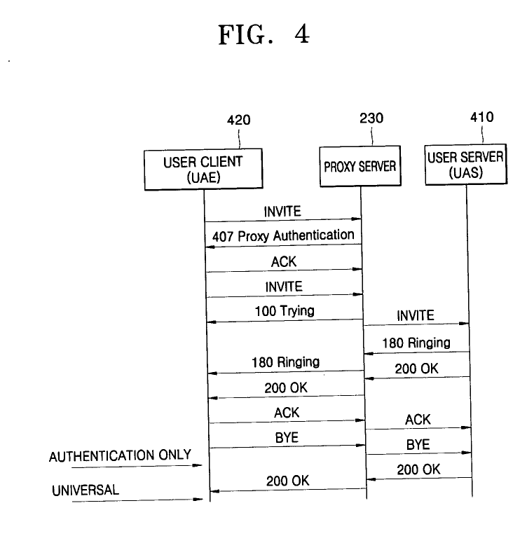

The projected protocol processing unit 110 is a physical entity into which two logical entities, i.e., a user server 410 of FIG. 4 and a client 420, are integrated. A caller 114 and a callee 112 in the projected protocol processing unit 110 are realized based on a projected protocol obtained by removing unnecessary paths of the protocol 210 input via the user environment processing unit 140. Multiple pairs of callers 114 and callees 112 may be formed as multiple threads, thereby realizing in real time a number of simultaneous calls.

The call generation unit 120 generates a request message and a response message in consideration of the states of the caller 114 and the callee 112, sends the generated request and response messages to the device 230 to be tested, i.e., a proxy server 230 of FIG. 4, via the signal conversion unit 150, and changes the states of the caller 114 and the callee 112 based on a response message received from the proxy server 230. The signal conversion unit 150 is a converter, which converts a logical message generated by the projected protocol processing unit 110 into a physical message transmittable to the proxy server 230 and converts a physical message transmitted by the proxy server 230 via a network into a logical message.

The data collection and statistical analysis unit 160 collects various state information from the call generation unit 120 and various response messages received from an external network via the signal conversion unit 150, calculates performance indexes of the protocol 210 to be tested and call setup time based on the collected state information and response messages, and notifies a user of the calculation results via the user environment processing unit 140.

The user environment processing unit 140 displays statistical data related to the performance indexes provided by the data collection and statistical analysis unit 160, describes the protocol 210 to be more understandable, and allows some of the paths of the protocol 210 to be tested to be designated as exemptions to the measuring of the performance of the protocol 210 to be tested carried out by the projection processing unit 130.

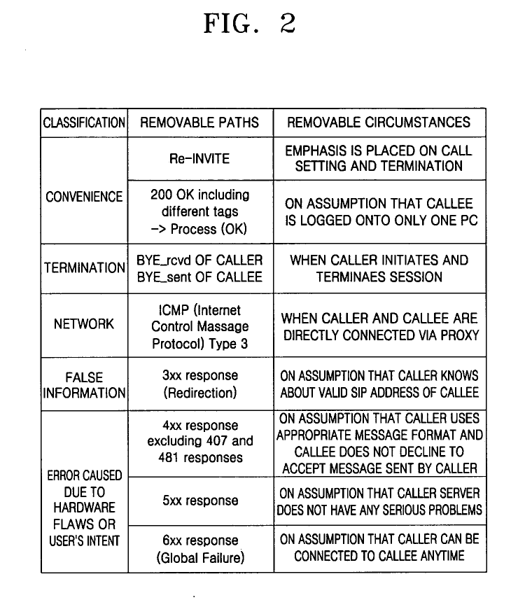

FIG. 2 is a diagram illustrating a table that specifies removable paths of an Internet phone protocol and circumstances under which the removable paths can be exempted from the measuring of the performance of the Internet phone protocol carried out by a system for measuring the performance of an Internet phone protocol according to an exemplary embodiment of the present invention. Referring to FIG. 2, removable paths of an Internet phone protocol are classified into different categories, i.e., ‘convenience’, ‘termination’, ‘network’, ‘false information’, and ‘errors caused by hardware flaws or a user's intent’. Removable paths classified into the first category, ‘convenience’, are paths that can be removed for the convenience of measuring the performance of an Internet phone protocol. Removable paths classified into the second category, ‘termination’, are paths that can be removed on the assumption that only one of a caller and a callee initiates a ‘BYE’ request. Removable paths classified into the third category, ‘network’, are paths that can be removed according to the state of a network. Removable paths classified into the fourth category, ‘false information’, are paths that can be removed when the caller has false termination information or when requirements regarding an SIP message (e.g., when an SIP message has an inappropriate format). Removable paths classified into the fifth category, ‘errors caused by hardware flaws or a user's intent’, are paths that can be removed when an entity is physically defective or when a user of a user agent declines to initiate a session.

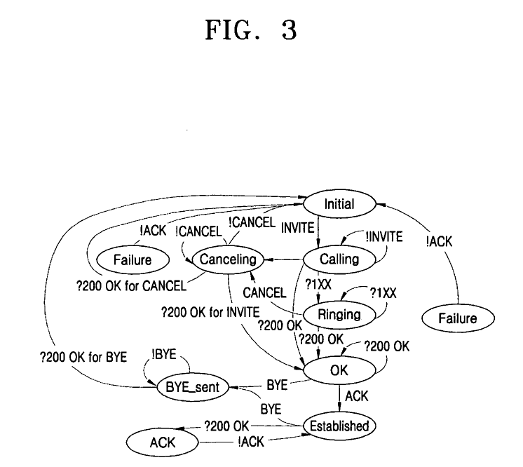

The removable paths listed in FIG. 2 correspond to exceptional paths illustrated in FIG. 3. Circumstances or assumptions under which removable paths can be removed will now be described in detail with reference to FIG. 2.

Re-INVITE

‘Re-INVITE’ indicates an occasion when a session is established in response to a 200 OK message, which is received as a response to a first INVITE message previously transmitted, and there is the need to transmit a second INVITE message in order to change media description of the session. An INVITE message is a message used for initiating a session and, particularly, for establishing a session between two end points for the first time. In addition, an INVITE message may be also used for changing existing session description if a session has already been established between two termination points. Session description desired by a caller is contained in a body of an INVITE message. Then, a callee who receives the INVITE message from the caller selects a media format that it can support from among a plurality of media formats included in the session description contained in the received INVITE message and includes the selected media format in a 200 OK message to be transmitted to the caller. The format of the session description included in the INVITE message follows a session description protocol (SDP) defined in RFC 2327 by the IETF.

In the ‘Re-INVITE’ state, an exceptional path becomes unnecessary and thus can be removed when there is no need to change session description and emphasis is placed on initial call setting and call termination.

200 OK with Different Tag

A user of an SIP has an SIP address of his or her own regardless of to which device and in what place he or she is currently logged on. Thus, if a user is simultaneously logged onto a plurality of instances and receives a response message from one of the instances, there is the need to determine from which one of the instances the response message has been transmitted. A 200 OK message is a response message used for determining from which one of the instances the response message has been transmitted.

In other words, if a user is simultaneously logged onto a plurality of instances, he or she may receive a plurality of 200 OK messages having different tags from one another in response to the same INVITE message. Therefore, a user agent which receives the 200 OK messages falls either into an OK state or into an established state in response to one of the 200 OK messages that has arrived at the user agent ahead of the rest of the 200 OK messages and then executes new processes in the OK state in response to the rest of the 200 OK messages, in which case, an exceptional path is generated.

Such exceptional path becomes unnecessary and can be removed if a callee is logged onto only one device at a stage of measuring the performance of an Internet phone protocol.

BYE Received of Caller and BYE Sent of Callee

BYE_received of Caller indicates an occasion when a caller receives a BYE request message from a callee, in other words, an occasion when the callee issues a request for termination of a session to the caller. On the other hand, BYE_received of Callee indicates an occasion when the callee receives a BYE request message from the caller, in other words, an occasion when the caller issues a request for termination of a session to the callee.

An exceptional path is likely to be generated when the callee, rather than the caller who initiates a session, issues a BYE request to the caller.

Supposing that only the caller is allowed to terminate a session, the exceptional path becomes unnecessary and thus can be removed when measuring the performance of an Internet phone protocol.

Internet Control Message Protocol (ICMP) Type 3

An ICMP is a network layer protocol used by hosts, routers, or gateways to transmit or receive network layer information, and an ICMP message is a message used for error notification.

When an ICMP type 3 destination unreachable message is received, an exceptional path may be generated according to network circumstances.

The system 100 of FIG. 1 is directly connected to the device 230 to be tested, i.e., a proxy server. Thus, there is little possibility of receiving the ICMP type 3 destination unreachable message, in which case, the exceptional path becomes unnecessary and thus can be removed.

3XX-6XX Responses

If an SIP address of a destination specified in an INVITE message is old and a registry has information on a new SIP address of the destination, the new SIP address of the destination is returned to a user client together with a 3XX response. When the user client receives the 3XX response, it may automatically transmit an INVITE message containing the new SIP address of the destination to a user or may simply notify the user of the new SIP address of the destination.

A 4XX response may be generated when there is a caller-related problem, such as when there is the need to authenticate the caller, when a callee does not support any of a plurality of media formats specified in session description of an INVITE message, or when the callee declines a session initiation request issued by the caller. In particular, 407 and 481 responses are taken into consideration in most cases of measuring the performance of an Internet phone protocol.

A 5XX response is likely to be generated when there is a callee-related problem, for example, in case of temporary overload.

A 6XX response is generated when a global error occurs. For example, in a case where a callee is logged onto a plurality of instances and decides not to receive a call from a caller in any of the instances, a 6XX response is returned to a proxy server. When receiving the 6XX response, the proxy server stops attempting to connect the predetermined caller to the callee and notifies the predetermined caller that the callee has declined to receive a call from him or her. Since a user client and a user server are objects to be tested and adjustable by an experimenter, the experimenter can prevent in advance such a global error from occurring, in which case, an exceptional path for the 6XX response and corresponding processing routines can be removed.

FIG. 3 is a projected state transition diagram illustrating an SIP used in a system and a method for measuring the performance of an Internet phone protocol according to an exemplary embodiment of the present invention. Specifically, FIG. 3 illustrates a projected SIP obtained by removing some of a plurality of paths of an SIP that have been established for a caller with reference to the table illustrated in FIG. 2 in order to measure the performance of the SIP.

FIG. 4 is a flowchart illustrating a system and a method for measuring the performance of an Internet phone protocol according to an exemplary embodiment of the present invention. Specifically, FIG. 4 is a projected message flowchart illustrating an SIP, which corresponds to the projected state transition diagram of FIG. 3, on the assumption that all the exceptional paths illustrated in FIG. 2 are removable.

Referring to FIG. 4, the proxy server 230, i.e., the device 230 to be tested of FIG. 1, serves an authentication function. A user client 420 transmits a first INVITE message that does not contain authentication information to a user server 410 via the proxy server 230. The proxy server 230 recognizes that the first INVITE message transmitted by the user client 420 does not include any authentication information and transmits a 407 response indicating that proxy authentication is required to the user client 410. The 407 response includes a nonce value.

The user client 410 receives the 407 response and transmits an acknowledgement (ACK) message to the proxy server 230. The ACK message does not reach the user server 420 but only arrives at the proxy server 230. If the ACK message is a response to a 401 response transmitted by the proxy server 230, it may be transmitted to the user server 420 as well as to the proxy server 230. The ACK message is transmitted only as a response to an INVITE request. In other words, the ACK message is not transmitted to the proxy server 230 in response to a request other than an INVITE request, for example, a BYE or CANCEL request.

The user client 420 transmits a second INVITE message containing authentication information requested by the 407 response and the nonce value contained in the 407 response to the proxy server 230.

The proxy server 230 receives the second INVITE message from the user client 420 and performs an authentication operation. If the second INVITE message includes legitimate authentication information, the proxy server 230 passes it over to the user server 410. In addition, the proxy server 230 generates a provisional message (i.e., a 100 Trying response message) and transmits it to the user client 420 so that the user client 420 can be prevented from transmitting another INVITE message.

The user server 410 receives the second INVITE message from the proxy server 230 and transmits a 180 Ringing response message to the proxy server 230 in response to the second INVITE message in order to indicate that it currently notifies a user of the reception of the second INVITE message. If the user accepts a session initiation request, for example, if the user decides to answer the phone and picks up the phone, the user server 410 notifies the user client 420 that the user has accepted the session initiation request by transmitting a 200 OK response message to the user client 230 via the proxy server 230.

The user client 420 receives the 200 OK response message and transmits an ACK message to the user server 410 in response to the 200 OK response message. However, if the user client 420 receives a 1XX provision response message, such as a 100 Trying response message or a 180 Ringing response message, instead of the 200 OK response message, it cannot determine yet whether a current attempt to initiate a session has been successful. Thus, the user client 420 stops transmitting another INVITE message to the user server 410 and notifies the user server 410 that it has received the 1XX provisional response message without transmitting an ACK message to the user server 410.

Both the user client 420 and the user server 410 may issue a BYE request and may respond to a BYE request issued thereto by transmitting a 200 OK response message. When issuing a BYE request and receiving a 200 OK response message in response to the BYE request, each of the user client 420 and the user server 410 does not transmit an ACK message because an ACK message can only be used as a response to an INVITE request.

Throughput and call setup time of the proxy server 230 are set as performance indexes of the proxy server 230 to be measured. The throughput of the proxy server 230 is represented as a maximum number of calls per second. The capacity of the proxy server 230 is saturated with as many SIP calls as possible by generating signals and transmitting the signals between a caller and a callee according to the projected message sequence illustrated in FIG. 4 and generating a new call setting message, e.g., an INVITE message, immediately after a previous iteration of call setting (particularly, after receiving a 200 OK response message in response to an INVITE message or after generating an ACK message in response to the 200 OK response message), and then, the throughput of the proxy server 230 is measured.

The callee transmits a provisional response message, e.g., a 1XX response message, in response to an INVITE message transmitted thereto according to the projected message sequence of FIG. 4 and transmits a 200 OK response message a predetermined amount of time later. The predetermined amount of time indicates the amount of time taken by an SIP user to pick up the phone after hearing the phone ringing and is determined based on statistics. The callee transmits a 200 OK response message immediately after receiving a BYE message for requesting termination of a call. In this manner, the performance of the proxy server 230 can be measured.

Accordingly, it is possible to efficiently measure the performance of an Internet phone protocol taking into consideration main functions of the Internet phone protocol separately from exceptional functions of the Internet phone protocol.

As described above, the system and method for measuring the performance of an Internet phone protocol according to the present invention measure the performance of an Internet phone protocol after projecting the Internet phone protocol by removing unnecessary, complex paths and the respective processing routines while taking into consideration main functions of the Internet phone protocol separately from exceptional functions of the Internet phone protocol. Accordingly, the system and method for measuring the performance of an Internet phone protocol according to the present invention are easy to be realized and highly efficient in terms of managing system resources.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A system for measuring the performance of an Internet phone protocol comprising:
a user environment processing unit, which receives a protocol to be tested and removable paths of the protocol to be tested and provides information on performance indexes;
a projection processing unit, which projects the protocol to be tested by removing unnecessary paths related to exceptional operations of the protocol to be tested in consideration of the removable paths of the protocol to be tested; and
a projected protocol processing unit, which applies the projected protocol to a caller and a callee to make the projected protocol ready to be tested.

2. The system of claim 1 further comprising:
a signal conversion unit, which converts a logical message generated together with the projected protocol into a physical message that can be interpreted by the device whose protocol needs to be tested and converts a physical message generated by the device whose protocol needs to be tested into a logical message that can be interpreted by the projected protocol processing unit;
a call generation unit, which generates a call corresponding to the projected protocol; and
a data collection and statistical analysis unit, which collects data generated by the signal conversion unit and the call generation unit and statistically analyzes the collected data,
wherein the Internet phone protocol is a session initiation protocol (SIP), and the device whose protocol needs to be tested is an SIP proxy server.

3. The system of claim 1, wherein the removable paths comprise:
a convenience path, which is removable for the convenience of measuring the performance of an Internet phone protocol;
a termination path, which is removable on the assumption that only one of the caller or the callee is able to issue a BYE request;
a network path, which is generated due to network circumstances;
a false information path, which is generated when the caller has false termination information or requirements related to the formation of an SIP message are not met; and
an error path, which is generated due to hardware flaws or a user's intent when entities have hardware flaws or a user of a user agent declines to initiate a session.

4. The system of claim 2, wherein the projected protocol processing unit realizes a plurality of pairs of callers and callees as multiple threads, which operate in parallel.

5. The system of claim 2, wherein the call generation unit generates a call setting request message at a user's request, the call setting request message is used for calculating the performance indexes together with data output from the signal conversion unit, and the user environment processing unit can view the performance indexes.

6. The system of claim 4, wherein the performance indexes comprise throughput and call setting time of the SIP proxy server, wherein the throughput of the SIP proxy server is represented by a maximum number of calls per sec.

7. A method of measuring the performance of an Internet phone protocol comprising:
projecting an Internet phone protocol to be tested by applying removable paths to the Internet phone protocol and then removing unnecessary paths related to exceptional processes; and
measuring the performance of the projected Internet phone protocol,
wherein the Internet phone protocol is an SIP, and the performance of the projected Internet phone protocol is measured using an SIP proxy server.

8. The method of claim 7, wherein the removable paths comprise:
a convenience path, which is removable for the convenience of measuring the performance of an Internet phone protocol;
a termination path, which is removable on the assumption that only one of the caller or the callee is able to issue a BYE request;
a network path, which is generated due to network circumstances;
a false information path, which is generated when the caller has false termination information or requirements related to the formation of an SIP message are not met;
an error path, which is generated due to hardware flaws or a user's intent when entities have hardware flaws or a user of a user agent declines to initiate a session.
